(19) United States
(12) Patent Application Publication
(10) Pub. No.: US 2014/0004485 A1
(43) Pub. Date: Jan. 2, 2014

(54) TECHNIQUES FOR ENHANCED HOLOGRAPHIC COOKING

(71) Applicants: Audrey C. Younkin, Hillsboro, OR (US); Marisol Martinez Escobar, Portland, OR (US)

(72) Inventors: Audrey C. Younkin, Hillsboro, OR (US); Marisol Martinez Escobar, Portland, OR (US)

(21) Appl. No.: 13/977,060

(22) PCT Filed: Mar. 30, 2012
(86) PCT No.: PCT/US2012/031548

§ 371 Date: Jun. 28, 2013

(51) Int. Cl. G09B 19/00

(52) U.S. Cl. CPC G09B 19/00
USPC 434/127

(57) ABSTRACT

Techniques for performing holographic cooking demonstrations are described. In one embodiment, for example, an apparatus may comprise a processor circuit and a holographic cooking demonstration module, and the holographic cooking demonstration module may be operable by the processor circuit to receive holographic cooking demonstration information, generate holographic cooking display information based on the holographic cooking demonstration information, and send the holographic cooking display information to a holographic display arranged to display holographic cooking demonstration user interface elements based on the holographic cooking display information. In this manner, holographic cooking demonstrations may be performed in a three-dimensional space comprising a workspace. Other embodiments are described and claimed.

### BACKGROUND

Increasing one's proficiency with respect to cooking may involve honing a wide variety of skills and learning a wide range of techniques and information. Using traditional techniques for cooking instruction, learning new skills, techniques, and information may be difficult, because when one's attention is focused on traditional instructional materials such as books and videos, it may be diverted away from objects, materials, ingredients, or tools to which the instructions pertain. Furthermore, traditional instructional materials may provide descriptions of techniques and concepts that are too vague to be clearly understood. Performing cooking instruction using holographic cooking demonstrations and other holographic techniques may allow new skills, techniques, and information to be learned without diverting focus from the cooking workspace, and allow more detailed and clear descriptions of relevant techniques and concepts. Accordingly, techniques for performing holographic cooking demonstrations are desirable.

### BRIEF DESCRIPTION OF THE DRAWINGS

FIG. 1 illustrates one embodiment of an apparatus and one embodiment of a system.

FIG. 2 illustrates one embodiment of a first logic flow.

FIG. 3 illustrates one embodiment of a second logic flow.

FIG. 4 illustrates one embodiment of a holographic display device.

FIG. 5 illustrates one embodiment of a second system.

FIG. 6 illustrates one embodiment of a third system.

FIG. 7 illustrates one embodiment of a device.

### DETAILED DESCRIPTION

Various embodiments may be generally directed to techniques for performing holographic cooking demonstrations. In one embodiment, for example, an apparatus may comprise a processor circuit and a holographic cooking demonstration module, and the holographic cooking demonstration module may be operable by the processor circuit to receive holographic cooking demonstration information, generate holographic cooking display information based on the holographic cooking demonstration information, and send the holographic cooking display information to a holographic display arranged to display holographic cooking demonstration user interface elements based on the holographic cooking display information. In this manner, holographic cooking demonstrations may be performed in a three-dimensional space comprising a workspace. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

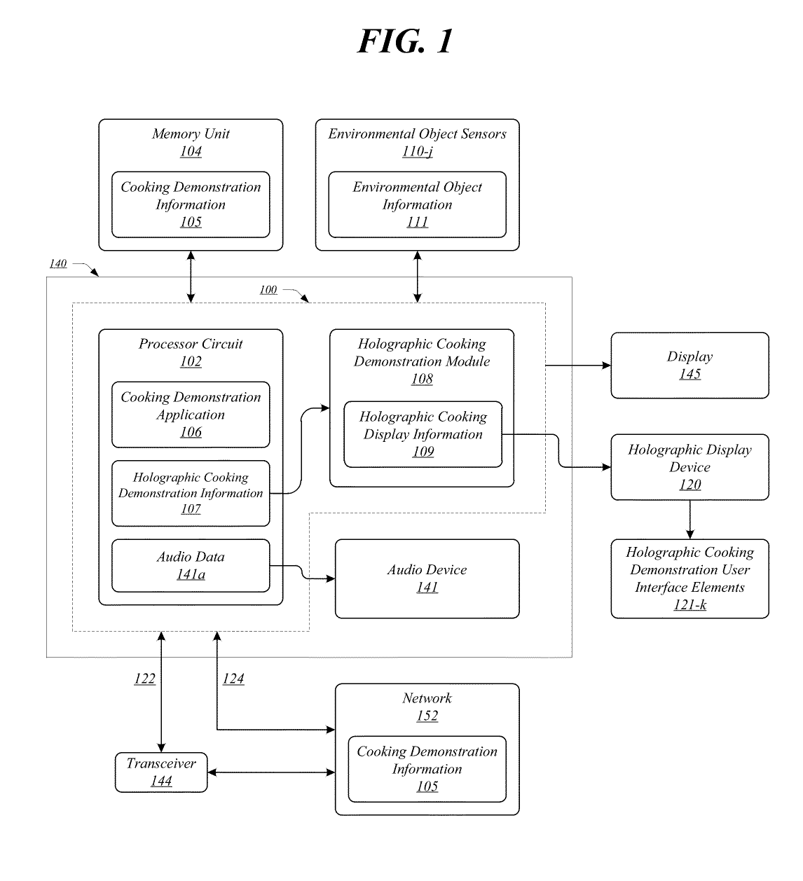

FIG. 1 illustrates a block diagram of an apparatus 100. As shown in FIG. 1, apparatus 100 comprises multiple elements including a processor circuit 102 and a holographic cooking demonstration module 108. The embodiments, however, are not limited to the type, number, or arrangement of elements shown in this figure.

In various embodiments, apparatus 100 may comprise processor circuit 102. Processor circuit 102 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 102 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In one embodiment, for example, processor circuit 102 may be implemented as a general purpose processor, such as a processor made by Intel® Corporation, Santa Clara, Calif. The embodiments are not limited in this context.

In some embodiments, apparatus 100 may comprise holographic cooking demonstration module 108. Holographic cooking demonstration module 108 may comprise logic or circuitry operative to process information, logic, instructions, or data received from processor circuit 102 and/or one or more elements external to apparatus 100 and to generate information, logic, instructions, or data based on the received information, logic, instructions, or data. Holographic cooking demonstration module 108 may comprise hardware, software, or a combination of both. The embodiments are not limited in this context.

FIG. 1 may also illustrate a block diagram of a system 140 in various embodiments. System 140 may comprise any of the aforementioned elements of apparatus 100. System 140 may further comprise an audio device 141 in some embodiments. Audio device 141 may comprise any device capable of generating tones, music, speech, speech utterances, sound effects, background noise, or other sounds based on received audio data. Examples of audio device 141 may include a speaker, a multi-speaker system, a home entertainment system, a television, a consumer appliance, a computer system, a mobile device, and a portable electronic media device, among other examples. The embodiments are not limited in this context.

In some embodiments, audio device 141 may be arranged to generate tones, music, speech, speech utterances, sound effects, background noise, or other sounds based on audio data 141a received from apparatus 100. In some embodiments, audio data 141a may be generated by processor circuit 102. The embodiments are not limited in this context.

In various embodiments, apparatus 100 and/or system 140 may comprise or be arranged to communicatively couple with a memory unit 104. Memory unit 104 may be implemented using any machine-readable or computer-readable media capable of storing data, including both volatile and non-volatile memory. For example, memory unit 104 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy of note that some portion or all of memory unit 104 may be included on the same integrated circuit as processor circuit 102 and/or holographic cooking demonstration module 108, or alternatively some portion or all of memory unit 104 may be disposed on an integrated circuit or other medium, for example a hard disk drive, that is external to the integrated circuit of processor circuit and/or holographic cooking demonstration module 108. Although memory unit 104 is external to apparatus 100 and system 140 in FIG. 1, memory unit 104 may be comprised within apparatus 100 and/or system 140 in some embodiments. The embodiments are not limited in this context.

In some embodiments, apparatus 100 and/or system 140 may comprise or be arranged to communicatively couple with one or more environmental object sensors 110-j. It is worthy of note that “j” and similar designators as used herein are intended to be variables representing any positive integer. Thus, for example, if an implementation sets a value for j=3, then a complete set of environmental object sensors 110-j may include environmental object sensors 110-1, 110-2, and 110-3. Environmental object sensor(s) 110-j may comprise any device(s) capable of sensing characteristics of the position, size, or motion of objects, materials, matter, or persons, and/or changes in objects, materials, or matter. In some embodiments, environmental object sensor(s) 110-j may sense characteristics of the position, size, dimensions, or motion of objects, materials, matter, or persons using radar, sonar, infrared or ultraviolet waves, image or video acquisition, gyroscopic motion detection, and/or other techniques. Although environmental object sensor(s) 110-j are external to apparatus 100 and system 140 in FIG. 1, environmental object sensor(s) 110-j may be comprised within apparatus 100 and/or system 140 in some embodiments. The embodiments are not limited in this context.

In various embodiments, apparatus 100 and/or system 140 may comprise or be arranged to communicatively couple with a holographic display device 120. Holographic display device 120 may comprise any device capable of rendering one or more holographic user interface elements. Holographic user interface elements may comprise any holographic visual or optical sensory effect(s) such as, for example, images, pictures, video, text, graphics, menus, textures, and/or patterns, and may comprise three-dimensional effects. In various embodiments, holographic display device 120 may comprise a holographic projector, and may render one or more holographic user interface elements using holographic projection. Holographic projection may comprise projecting one or more light fields towards a particle cloud to produce three dimensional effects. When used to render a three-dimensional image of an object, holographic projection may comprise reproducing the light that would be incident upon one or more vantage points from a rendering location if the object were actually present at the rendering location. For example, rendering a three-dimensional image of an apple using holographic projection may comprise reproducing the light that would be incident upon the eyes of a viewer at various vantage points from a countertop if the apple were actually present on the countertop. In various embodiments, holographic display device 120 may be operative to render one or more two-dimensional user interface elements on a surface within a three-dimensional space. For example, holographic display device 120 may be operative to display a recipe on a countertop. Although holographic display device 120 is external to apparatus 100 and system 140 in FIG. 1, holographic display device 120 may be comprised within apparatus 100 and/or system 140 in some embodiments. The embodiments are not limited in this context.

In some embodiments, apparatus 100 and/or system 140 may comprise or be arranged to communicatively couple with a transceiver 144. Transceiver 144 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 144 may operate in accordance with one or more applicable standards in any version. Although transceiver 144 is external to apparatus 100 and system 140 in FIG. 1, transceiver 144 may be comprised within apparatus 100 and/or system 140 in some embodiments. The embodiments are not limited in this context.

In various embodiments, apparatus 100 and/or system 140 may be arranged to communicate with a network 152. Apparatus 100 and/or system 140 may be communicatively coupled to network 152 via a wireless communications medium 122, a wired communications medium 124, or both. A wireless connection to network 152 using wireless communications medium 122 may be implemented using transceiver 144. Examples of wired communications medium 124 may include a wire, cable, metal leads, printed circuit board (PCB), backplane, switch fabric, semiconductor material, twisted-pair wire, co-axial cable, fiber optics, and so forth. The embodiments are not limited in this context.

In various embodiments, apparatus 100 and/or system 140 may comprise or be arranged to communicatively couple with a display 145. Display 145 may comprise any device capable of displaying any visual or optical sensory effect(s) such as, for example, images, pictures, video, text, graphics, menus, textures, and/or patterns. Examples for display 145 may include a television, a monitor, a projector, and a computer screen. In one embodiment, for example, display 145 may be implemented by a liquid crystal display (LCD) display, a light emitting diode (LED) display, or other types of suitable visual interfaces. Display 145 may comprise, for example, a touch-sensitive color display screen. In various implementations, display 145 may comprise one or more thin-film transistors (TFT) LCD including embedded transistors. Although display 145 is external to apparatus 100 and system 140 in FIG. 1, display 145 may be comprised within apparatus 100 and/or system 140 in some embodiments. The embodiments are not limited in this context.

In some embodiments, processor circuit 102 may be operable to execute a cooking demonstration application 106. Cooking demonstration application 106 may comprise any application capable of generating holographic cooking demonstration information 107. Holographic cooking demonstration information 107 may comprise data, information, or logic corresponding to one or more holographic cooking demonstration user interface elements 121-k. The data, information, or logic comprised within holographic cooking demonstration information 107 may be usable by apparatus 100, system 140, and/or one or more elements external to apparatus 100 and/or system 140 to cause one or more holographic cooking demonstration user interface elements 121-k to be rendered by holographic display device 120. In some embodiments, holographic cooking demonstration information 107 may comprise application-level graphics instructions and/or data. The embodiments are not limited in this context.

In various embodiments, apparatus 100 and/or system 140 may receive cooking demonstration information 105, and cooking demonstration application 106 may be operative on processor circuit 102 to generate holographic cooking demonstration information 107 based on cooking demonstration information 105. In various embodiments, apparatus 100 and/or system 140 may receive cooking demonstration information 105 from memory unit 104, network 152, or both. Cooking demonstration information 105 may comprise data, information, or logic corresponding to one or more cooking techniques, recipes, ingredients, tools, safety precautions, visual depictions of prepared food or drink, human movements corresponding to cooking operations, or any other data, information, or logic pertaining to principles, theories, operations, illustrations, or information relating to cooking For example, cooking demonstration information 105 may comprise information corresponding to a recipe, and cooking demonstration application 106 may be operative on processor circuit 102 to generate holographic cooking demonstration information 107 corresponding to one or more holographic cooking demonstration user interface elements 121-k that when rendered, illustrate one or more operations involved in preparing the recipe. The embodiments are not limited to this example.

In some embodiments, prior to generating holographic cooking demonstration information 107, processor circuit 102 may receive environmental object information 111 from environmental object sensor(s) 110-j. Processor circuit 102 may then generate holographic cooking demonstration information 107 based on cooking demonstration information 105 and environmental object information 111. For example, cooking demonstration information 105 may comprise information corresponding to a technique for slicing an onion, and environmental object information 111 may comprise information describing the position and dimensions of an onion in a three-dimensional space. Based on cooking demonstration information 105 and environmental object information 111, processor circuit 102 may generate holographic cooking demonstration information 107 corresponding to one or more holographic cooking demonstration user interface elements 121-k that when rendered, display lines on the onion that illustrate where the onion should be sliced according to the technique to which cooking demonstration information 105 correspond. The embodiments are not limited to this example.

In various embodiments, environmental object sensor(s) 110-j may detect changes in one or more materials that comprise components of a recipe. Components of a recipe may include, for example, ingredients, cooking media such as burners, flames, water, steam, or oil, and/or cooking vessels such as pots and pans. Environmental object sensor(s) 110-j may then generate environmental object information 111 comprising information indicating changes detected in one or more materials that comprise components of a recipe. In an example embodiment, a recipe may involve heating water to its boiling point and cooking vegetables in the boiling water, and environmental object sensor(s) 110-j may detect a change in the water when the water transitions from a non-boiling state to a boiling state. Environmental object sensor(s) 110-j may then generate environmental object information 111 comprising information indicating the change in the water corresponding to the transition into the boiling state. The embodiments are not limited to this example.

In general operation, holographic cooking demonstration module 108 may be operative to cause holographic display device 120 to render one or more holographic cooking demonstration user interface elements 121-k. In some embodiments, holographic cooking demonstration module 108 may be operative to receive holographic cooking demonstration information 107, generate holographic cooking display information 109 based on holographic cooking demonstration information 107, and send holographic cooking display information 109 to holographic display device 120. Holographic cooking display information 109 may comprise data, information, or logic corresponding to the same holographic cooking demonstration user interface element(s) 121-k as holographic cooking demonstration information 107, but at a further stage of the graphics pipeline than that of holographic cooking demonstration information 107. For example, in various embodiments, holographic cooking demonstration information 107 may comprise application-level graphics instructions and/or data, and holographic cooking display information 109 may comprise intensities and/or colors of one or more light fields. In various embodiments, holographic display device 120 may be arranged to render holographic cooking demonstration user interface elements 121-k in a three-dimensional space based on holographic cooking display information 109. The embodiments are not limited in this context.

In some embodiments, holographic display 120 may be operative to receive holographic cooking display information 109 and render holographic cooking demonstration user interface elements 121-k in a three-dimensional space based on holographic cooking display information 109. For example, in some embodiments, holographic cooking display information 109 may comprise color and/or intensity values for light fields, holographic display 120 may project light fields according to those color and/or intensity values, and the projected light fields may be incident upon a particle cloud to form one or more images, pictures, video, text, graphics, menus, textures, and/or patterns that constitute holographic cooking demonstration user interface elements 121-k. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

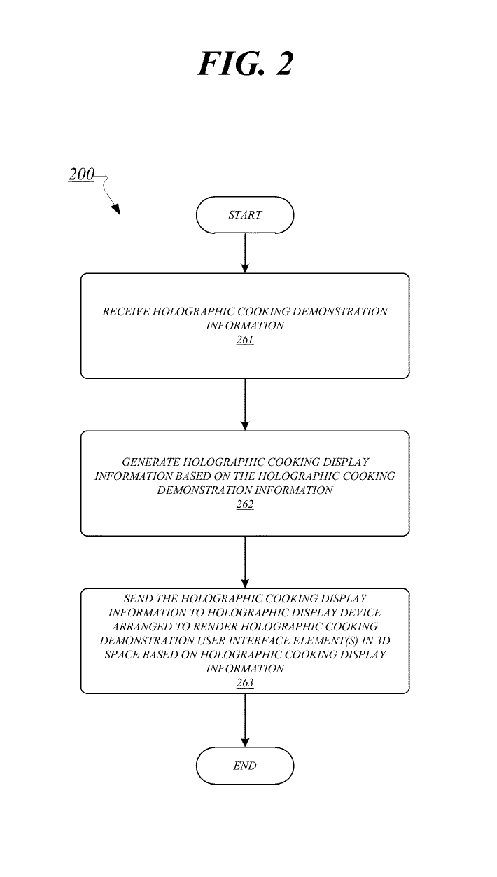

FIG. 2 illustrates one embodiment of a logic flow 200, which may be representative of the operations executed by one or more embodiments described herein. As shown in logic flow 200, holographic cooking demonstration information may be received at 261. For example, holographic cooking demonstration module 108 of FIG. 1 may receive holographic cooking demonstration information 107 from processor circuit 102. At 262, holographic cooking display information may be generated based on the holographic cooking demonstration information. For example, holographic cooking demonstration module 108 of FIG. 1 may generate holographic cooking display information 109 based on holographic cooking demonstration information 107. At 263, the holographic cooking display information may be sent to a holographic display device arranged to render holographic cooking demonstration user interface elements in a three-dimensional space based on the holographic cooking display information. For example, holographic cooking display information 109 of FIG. 1 may be send to holographic display device 120, which may be arranged to render holographic cooking demonstration user interface elements 121-k in a three-dimensional space based on holographic cooking display information 109. The embodiments are not limited to these examples.

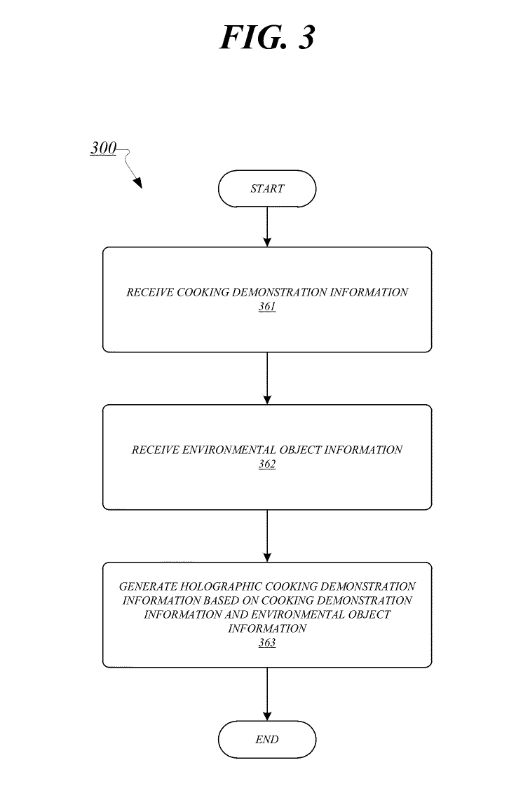

FIG. 3 illustrates one embodiment of a logic flow 300, which may be representative of the operations executed by one or more embodiments described herein. As shown in logic flow 300, cooking demonstration information may be received at 361. For example, apparatus 100 and/or system 140 of FIG. 1 may receive cooking demonstration information 107 from memory unit 104 and/or network 152. At 362, environmental object information may be received. For example, apparatus 100 and/or system 140 of FIG. 1 may receive environmental object information 111 from environmental object sensor(s) 110-j. At 363, holographic cooking demonstration information may be generated based on the cooking demonstration information and the environmental object information. For example, processor circuit 102 of FIG. 1 may generate holographic cooking demonstration information 107 based on cooking demonstration information 105 and environmental object information 111. The embodiments are not limited to these examples.

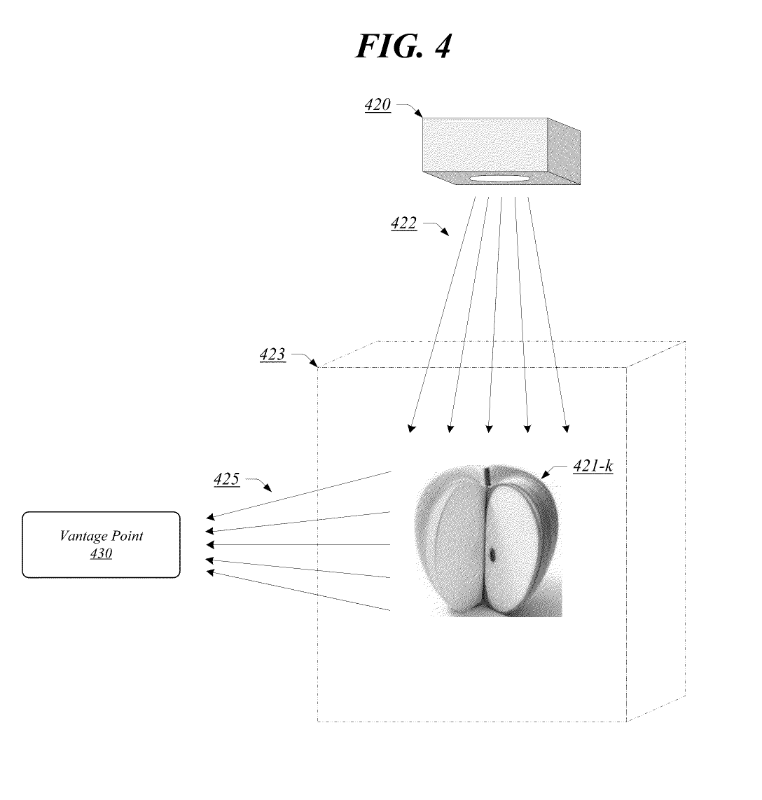

FIG. 4 illustrates one embodiment of a holographic display device 420. In FIG. 4, a holographic display device 420 projects light fields 422. Light fields 422 pass into workspace 423, where they intersect a particle cloud (not pictured) to create reflected light 425. Reflected light 425 passes from workspace 423 to vantage point 430 and is incident upon vantage point 430 such as to reproduce the light that would be incident upon vantage point 430 if a partially sliced apple were located in workspace 423, thus rendering holographic cooking demonstration user interface element 421-k, a three-dimensional holographic depiction of a partially sliced apple. The embodiments are not limited in this context.

Although the embodiment of FIG. 4 references a holographic display device 420 that projects light fields 422 into a particle cloud, the embodiments are not limited to this example. Other embodiments may utilize other suitable technology capable of rendering holographic and/or three-dimensional images. For example, in some embodiments, holographic cooking demonstration user interface element(s) 421-k may be rendered using projected light fields in combination with polarized or shuttered stereoscopic glasses. In other embodiments, holographic cooking demonstration user interface element(s) 421-k may be rendered by passing light waves through lenticular lens arrays or parallax barriers. In yet other embodiments, holographic cooking demonstration user interface element(s) 421-k may be rendered by using eye tracking systems to track a point of gaze of a user and adjust displayed images or light fields based on the point of gaze. The embodiments are not limited to these examples.

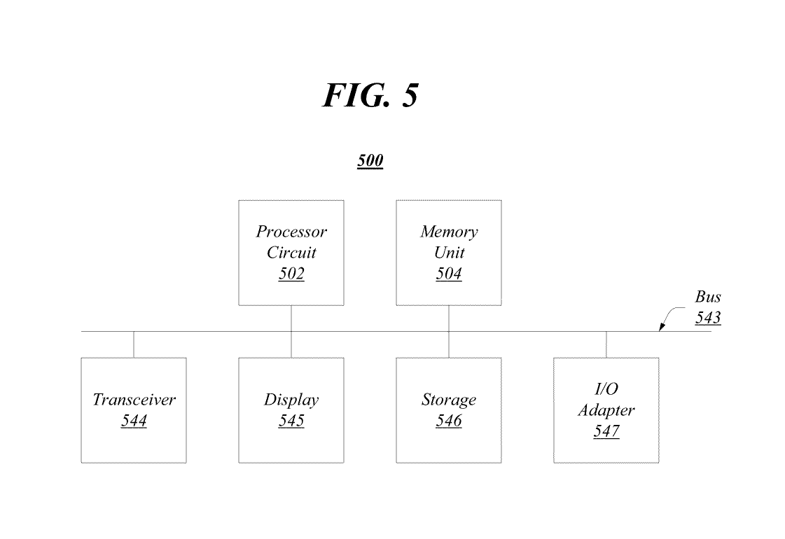

FIG. 5 illustrates one embodiment of a system 500. In various embodiments, system 500 may be representative of a system or architecture suitable for use with one or more embodiments described herein, such as apparatus 100 and/or system 140 of FIG. 1, logic flows 200 and 300 of FIGS. 2 and 3, or holographic display device 420 of FIG. 4. The embodiments are not limited in this respect.

As shown in FIG. 5, system 500 may comprise multiple elements. One or more elements may be implemented using one or more circuits, components, registers, processors, software subroutines, modules, or any combination thereof, as desired for a given set of design or performance constraints. Although FIG. 5 shows a limited number of elements in a certain topology by way of example, it can be appreciated that more or less elements in any suitable topology may be used in system 500 as desired for a given implementation. The embodiments are not limited in this context.

In various embodiments, system 500 may include a processor circuit 502. Processor circuit 502 may be implemented using any processor or logic device, and may be the same as or similar to processor circuit 102 of FIG. 1.

In one embodiment, system 500 may include a memory unit 504 to couple to processor circuit 502. Memory unit 504 may be implemented using any machine-readable or computer-readable media capable of storing data, including both volatile and non-volatile memory, and may be the same as or similar to memory unit 104 of FIG. 1.

In various embodiments, system 500 may include a transceiver 544. Transceiver 544 may include one or more radios capable of transmitting and receiving signals using various suitable wireless communications techniques, and may be the same as or similar to transceiver 144 of FIG. 1. Such techniques may involve communications across one or more wireless networks. In communicating across such networks, transceiver 544 may operate in accordance with one or more applicable standards in any version. The embodiments are not limited in this context.

In various embodiments, system 500 may include a display 545. Display 545 may comprise any television type monitor or display. Display 545 may comprise any display device capable of displaying information received from processor circuit 502, and may be the same as or similar to display 145 of FIG. 1. The embodiments are not limited in this context.

In various embodiments, system 500 may include storage 546. Storage 546 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 546 may comprise technology to increase the storage performance enhanced protection for valuable digital media when multiple hard drives are included, for example. Further examples of storage 546 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, system 500 may include one or more I/O adapters 547. Examples of I/O adapters 547 may include Universal Serial Bus (USB) ports/adapters, IEEE 1394 Firewire ports/adapters, and so forth. The embodiments are not limited in this context.

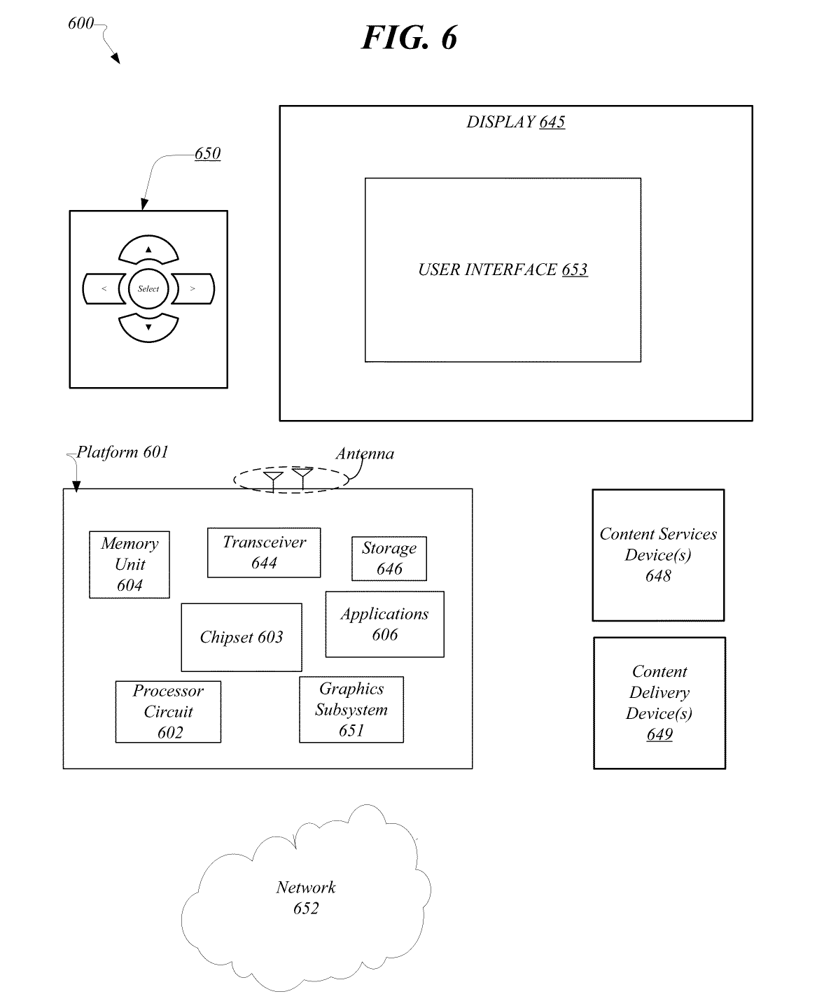

FIG. 6 illustrates an embodiment of a system 600. In various embodiments, system 600 may be representative of a system or architecture suitable for use with one or more embodiments described herein, such as apparatus 100 and/or system 140 of FIG. 1, logic flows 200 and 300 of FIGS. 2 and 3, holographic display device 420 of FIG. 4, or system 500 of FIG. 5. The embodiments are not limited in this respect.

As shown in FIG. 6, system 600 may comprise multiple elements. One or more elements may be implemented using one or more circuits, components, registers, processors, software subroutines, modules, or any combination thereof, as desired for a given set of design or performance constraints. Although FIG. 6 shows a limited number of elements in a certain topology by way of example, it can be appreciated that more or less elements in any suitable topology may be used in system 600 as desired for a given implementation. The embodiments are not limited in this context.

In embodiments, system 600 may be a media system although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 600 comprises a platform 601 coupled to a display 645. Platform 601 may receive content from a content device such as content services device(s) 648 or content delivery device(s) 649 or other similar content sources. A navigation controller 650 comprising one or more navigation features may be used to interact with, for example, platform 601 and/or display 645. Each of these components is described in more detail below.

In embodiments, platform 601 may comprise any combination of a processor circuit 602, chipset 603, memory unit 604, applications 606, transceiver 644, storage 646, and/or graphics subsystem 651. Chipset 603 may provide intercommunication among processor circuit 602, memory unit 604, applications 606, transceiver 644, storage 646, and/or graphics subsystem 651. For example, chipset 603 may include a storage adapter (not depicted) capable of providing intercommunication with storage 646.

Processor circuit 602 may be implemented using any processor or logic device, and may be the same as or similar to processor circuit 502 in FIG. 5.

Memory unit 604 may be implemented using any machine-readable or computer-readable media capable of storing data, and may be the same as or similar to memory unit 504 in FIG. 5.

Transceiver 644 may include one or more radios capable of transmitting and receiving signals using various suitable wireless communications techniques, and may be the same as or similar to transceiver 544 in FIG. 5.

Display 645 may comprise any television type monitor or display, and may be the same as or similar to display 545 in FIG. 5.

Storage 646 may be implemented as a non-volatile storage device, and may be the same as or similar to storage 546 in FIG. 5.

Graphics subsystem 651 may perform processing of images such as still or video for display. Graphics subsystem 651 may be a graphics processing unit (GPU) or a visual processing unit (VPU), for example. An analog or digital interface may be used to communicatively couple graphics subsystem 651 and display 645. For example, the interface may be any of a High-Definition Multimedia Interface, DisplayPort, wireless HDMI, and/or wireless HD compliant techniques. Graphics subsystem 651 could be integrated into processor circuit 602 or chipset 603. Graphics subsystem 651 could be a stand-alone card communicatively coupled to chipset 603.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 648 may be hosted by any national, international and/or independent service and thus accessible to platform 601 via the Internet, for example. Content services device(s) 648 may be coupled to platform 601 and/or to display 645. Platform 601 and/or content services device(s) 648 may be coupled to a network 652 to communicate (e.g., send and/or receive) media information to and from network 652. Content delivery device(s) 649 also may be coupled to platform 601 and/or to display 645.

In embodiments, content services device(s) 648 may comprise a cable television box, personal computer, network, telephone, Internet enabled devices or appliance capable of delivering digital information and/or content, and any other similar device capable of unidirectionally or bidirectionally communicating content between content providers and platform 601 and/display 645, via network 652 or directly. It will be appreciated that the content may be communicated unidirectionally and/or bidirectionally to and from any one of the components in system 600 and a content provider via network 652. Examples of content may include any media information including, for example, video, music, medical and gaming information, and so forth.

Content services device(s) 648 receives content such as cable television programming including media information, digital information, and/or other content. Examples of content providers may include any cable or satellite television or radio or Internet content providers. The provided examples are not meant to limit embodiments of the invention.

In embodiments, platform 601 may receive control signals from navigation controller 650 having one or more navigation features. The navigation features of navigation controller 650 may be used to interact with a user interface 653, for example. In embodiments, navigation controller 650 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 650 may be echoed on a display (e.g., display 645) by movements of a pointer, cursor, focus ring, or other visual indicators displayed on the display. For example, under the control of software applications 606, the navigation features located on navigation controller 650 may be mapped to virtual navigation features displayed on user interface 653. In embodiments, navigation controller 650 may not be a separate component but integrated into platform 601 and/or display 645. Embodiments, however, are not limited to the elements or in the context shown or described herein.

In embodiments, drivers (not shown) may comprise technology to enable users to instantly turn on and off platform 601 like a television with the touch of a button after initial boot-up, when enabled, for example. Program logic may allow platform 601 to stream content to media adaptors or other content services device(s) 648 or content delivery device(s) 649 when the platform is turned “off.” In addition, chip set 603 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 600 may be integrated. For example, platform 601 and content services device(s) 648 may be integrated, or platform 601 and content delivery device(s) 649 may be integrated, or platform 601, content services device(s) 648, and content delivery device(s) 649 may be integrated, for example. In various embodiments, platform 601 and display 645 may be an integrated unit. Display 645 and content service device(s) 648 may be integrated, or display 645 and content delivery device(s) 649 may be integrated, for example. These examples are not meant to limit the invention.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF or infrared (IR) spectrum and so forth. When implemented as a wired system, system 600 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 601 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones, and so forth. Control information may refer to any data representing commands, instructions, or control words meant for an automated system. For example, control information may be used to route media information through a system, or instruct a node to process the media information in a predetermined manner. The embodiments, however, are not limited to the elements or in the context shown or described in FIG. 6.

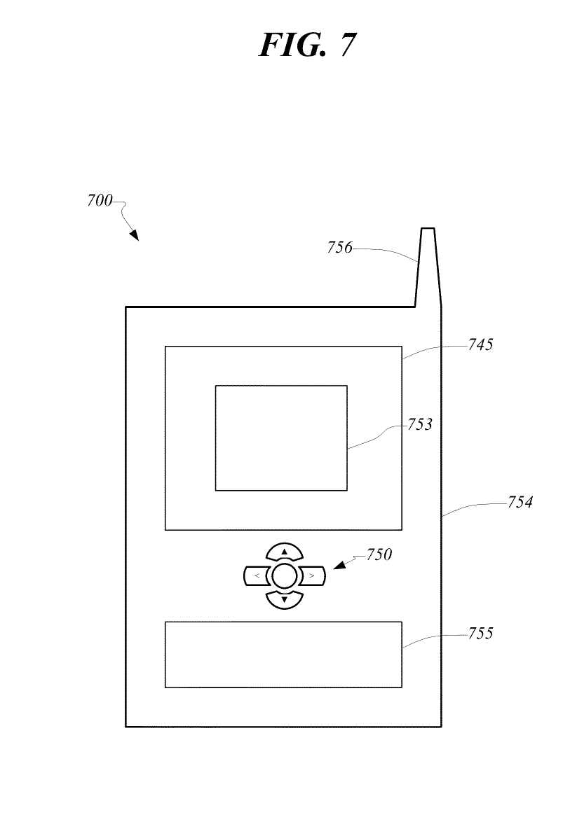

As described above, system 600 may be embodied in varying physical styles or form factors. FIG. 7 illustrates embodiments of a small form factor device 700 in which system 600 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may comprise a display 745, a navigation controller 750, a user interface 753, a housing 754, an I/O device 755, and an antenna 756. Display 745 may comprise any suitable display unit for displaying information appropriate for a mobile computing device, and may be the same as or similar to display 645 in FIG. 6. Navigation controller 750 may comprise one or more navigation features which may be used to interact with user interface 753, and may be the same as or similar to navigation controller 650 in FIG. 6. I/O device 755 may comprise any suitable I/O device for entering information into a mobile computing device. Examples for I/O device 755 may include an alphanumeric keyboard, a numeric keypad, a touch pad, input keys, buttons, switches, rocker switches, microphones, speakers, voice recognition device and software, and so forth. Information also may be entered into device 700 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

A computer-implemented method may comprise receiving, by a holographic cooking demonstration module communicatively coupled to a processor circuit, holographic cooking demonstration information, generating, by the holographic cooking demonstration module, holographic cooking display information based on the holographic cooking demonstration information, and sending the holographic cooking display information to a holographic display device arranged to render one or more holographic cooking demonstration user interface elements in a three-dimensional space based on the holographic cooking display information.

Such a computer-implemented method may comprise receiving cooking demonstration information and generating the holographic cooking demonstration information based on the cooking demonstration information.

Such a computer-implemented method may comprise receiving environmental object information from an environmental object sensor and generating the holographic cooking demonstration information based on the environmental object information.

According to such a computer-implemented method, the three-dimensional space may comprise a workspace, the environmental object information may comprise a location and dimensions of the workspace, and the holographic display device may be arranged to render the holographic cooking demonstration user interface elements within the workspace.

According to such a computer-implemented method, the environmental object information may comprise identifying information for one or more objects within the workspace or locations of the one or more objects within the workspace.

According to such a computer-implemented method, the environmental object information may comprise information indicating changes detected in one or more materials that comprise components of a recipe.

According to such a computer-implemented method, the holographic cooking demonstration information may correspond to a recipe, and the holographic cooking demonstration user interface elements may visually depict one or more operations corresponding to preparation of food or drink according to the recipe.

According to such a computer-implemented method, the holographic cooking demonstration information may correspond to a cooking technique, and the holographic cooking demonstration user interface elements may visually depict one or more operations corresponding to performance of the cooking technique.

According to such a computer-implemented method, the holographic cooking demonstration information may correspond to a safety precaution, and the holographic cooking demonstration user interface elements may visually depict one or more operations corresponding to compliance with the safety precaution.

According to such a computer-implemented method, the holographic cooking demonstration user interface elements may visually depict a volume or amount of an ingredient.

According to such a computer-implemented method, the holographic cooking demonstration user interface elements may visually depict a cooking implement.

According to such a computer-implemented method, the holographic cooking demonstration user interface elements may visually depict human movements corresponding to cooking operations.

According to such a computer-implemented method, the holographic cooking demonstration user interface elements may visually depict prepared food or drink corresponding to a completed recipe.

Such a computer-implemented method may comprise rendering one or more two-dimensional user interface elements on a surface within the three-dimensional space.

At least one machine readable medium may comprise a plurality of instructions that in response to being executed on a computing device, cause the computing device to carry out such a computer-implemented method.

An apparatus may comprise means for performing such a computer-implemented method.

An apparatus may comprise a processor circuit and a holographic cooking demonstration module communicatively coupled to the processor circuit, and the holographic cooking demonstration module may be operative to receive holographic cooking demonstration information, generate holographic cooking display information based on the holographic cooking demonstration information, and send the holographic cooking display information to a holographic display device arranged to render one or more holographic cooking demonstration user interface elements in a three-dimensional space based on the holographic cooking display information.

With respect to such an apparatus, the processor circuit may be operative to receive cooking demonstration information and generate the holographic cooking demonstration information based on the cooking demonstration information.

With respect to such an apparatus, the holographic cooking demonstration module may be operative to receive environmental object information from an environmental object sensor and generate the holographic cooking display information based on the environmental object information.

With respect to such an apparatus, the three-dimensional space may comprise a workspace, the environmental object information may comprise a location and dimensions of the workspace, and the holographic display device may be arranged to render the holographic cooking demonstration user interface elements within the workspace.

With respect to such an apparatus, the environmental object information may comprise identifying information for one or more objects within the workspace or locations of the one or more objects within the workspace.

With respect to such an apparatus, the environmental object information may comprise information indicating changes detected in one or more materials that comprise components of a recipe.

With respect to such an apparatus, the holographic cooking demonstration information may correspond to a recipe, and the holographic cooking demonstration user interface elements may visually depict one or more operations corresponding to preparation of food or drink according to the recipe.

With respect to such an apparatus, the holographic cooking demonstration information may correspond to a cooking technique, and the holographic cooking demonstration user interface elements may visually depict one or more operations corresponding to performance of the cooking technique.

With respect to such an apparatus, the holographic cooking demonstration information may correspond to a safety precaution, and the holographic cooking demonstration user interface elements may visually depict one or more operations corresponding to compliance with the safety precaution.

With respect to such an apparatus, the holographic cooking demonstration user interface elements may visually depict a volume or amount of an ingredient.

With respect to such an apparatus, the holographic cooking demonstration user interface elements may visually depict a cooking implement.

With respect to such an apparatus, the holographic cooking demonstration user interface elements may visually depict human movements corresponding to cooking operations.

With respect to such an apparatus, the holographic cooking demonstration user interface elements may visually depict prepared food or drink corresponding to a completed recipe.

Such an apparatus may be operative to render one or more two-dimensional user interface elements on a surface within the three-dimensional space.

A system may comprise such an apparatus and an audio device communicatively coupled to the processor circuit within such an apparatus.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-31. (canceled)

32. A computer-implemented method, comprising:
receiving, by a holographic cooking demonstration module communicatively coupled to a processor circuit, holographic cooking demonstration information;
generating, by the holographic cooking demonstration module, holographic cooking display information based on the holographic cooking demonstration information; and
sending the holographic cooking display information to a holographic display device arranged to render one or more holographic cooking demonstration user interface elements in a three-dimensional space based on the holographic cooking display information.

33. The computer-implemented method of claim 32, comprising:
receiving cooking demonstration information; and
generating the holographic cooking demonstration information based on the cooking demonstration information.

34. The computer-implemented method of claim 32, comprising:
receiving environmental object information from an environmental object sensor; and
generating the holographic cooking demonstration information based on the environmental object information.

35. The computer-implemented method of claim 34, the three-dimensional space comprising a workspace, the environmental object information comprising a location and dimensions of the workspace, the holographic display device arranged to render the holographic cooking demonstration user interface elements within the workspace.

36. The computer-implemented method of claim 35, the environmental object information comprising identifying information for one or more objects within the workspace or locations of the one or more objects within the workspace.

37. The computer-implemented method of claim 35, the environmental object information comprising information indicating changes detected in one or more materials that comprise components of a recipe.

38. The computer-implemented method of claim 32, the holographic cooking demonstration information corresponding to one of a recipe, a cooking technique or a safety precaution.

39. The computer-implemented method of claim 38, the holographic cooking demonstration user interface elements visually depicting operations corresponding to one of preparation of food or drink according to the recipe, performance of the cooking technique or compliance with the safety precaution.

40. The computer-implemented method of claim 32, the holographic cooking demonstration user interface elements visually depicting one of a volume of an ingredient, an amount of an ingredient, a cooking implement, human movement corresponding to cooking operations, food corresponding to a completed recipe or a drink corresponding to a completed recipe.

41. The computer-implemented method of claim 32, comprising rendering one or more two-dimensional user interface elements on a surface within the three-dimensional space.

42. At least one machine-readable medium comprising a plurality of instructions that in response to being executed on a computing device, cause the computing device to:
receive, by a holographic cooking demonstration module communicatively coupled to a processor circuit, holographic cooking demonstration information;
generate, by the holographic cooking demonstration module, holographic cooking display information based on the holographic cooking demonstration information; and
send the holographic cooking display information to a holographic display device arranged to render one or more holographic cooking demonstration user interface elements in a three-dimensional space based on the holographic cooking display information.

43. The at least one machine-readable medium of claim 42, the computer device to:
receive cooking demonstration information; and
generate the holographic cooking demonstration information based on the cooking demonstration information.

44. The at least one machine-readable medium of claim 42, the computer device to:
receive environmental object information from an environmental object sensor; and
generate the holographic cooking demonstration information based on the environmental object information.

45. The at least one machine-readable medium of claim 44, the three-dimensional space comprising a workspace, the environmental object information comprising a location and dimensions of the workspace, the holographic display device arranged to render the holographic cooking demonstration user interface elements within the workspace.

46. An apparatus, comprising:
a processor circuit; and
a holographic cooking demonstration module communicatively coupled to the processor circuit, the holographic cooking demonstration module operative to:
receive holographic cooking demonstration information;
generate holographic cooking display information based on the holographic cooking demonstration information; and
send the holographic cooking display information to a holographic display device arranged to render one or more holographic cooking demonstration user interface elements in a three-dimensional space based on the holographic cooking display information.

47. The apparatus of claim 46, the processor circuit operative to receive cooking demonstration information and generate the holographic cooking demonstration information based on the cooking demonstration information.

48. The apparatus of claim 46, the holographic cooking demonstration module operative to:
receive environmental object information from an environmental object sensor; and
generate the holographic cooking display information based on the environmental object information.

49. The apparatus of claim 45, the three-dimensional space comprising a workspace, the environmental object information comprising a location and dimensions of the workspace, the holographic display device arranged to render the holographic cooking demonstration user interface elements within the workspace.

50. The apparatus of claim 49, the environmental object information comprising identifying information for one or more objects within the workspace or locations of the one or more objects within the workspace.

51. The apparatus of claim 49, the environmental object information comprising information indicating changes detected in one or more materials that comprise components of a recipe.

52. The apparatus of claim 46, the holographic cooking demonstration information corresponding to one of a recipe, a cooking technique or a safety precaution.

53. The apparatus of claim 52, the holographic cooking demonstration user interface elements visually depicting operations corresponding to one of preparation of food or drink according to the recipe, performance of the cooking technique or compliance with the safety precaution.

54. The apparatus of claim 46, the holographic cooking demonstration user interface elements visually depicting one of a volume of an ingredient, an amount of an ingredient, a cooking implement, human movements corresponding to cooking operations, prepared food corresponding to a completed recipe or a prepared drink corresponding to a completed recipe.

55. The apparatus of claim 43, operative to render one or more two-dimensional user interface elements on a surface within the three-dimensional space.

56. A system, comprising:
a processor circuit; and
an audio device communicatively coupled to the processor circuit.
a holographic cooking demonstration module communicatively coupled to the processor circuit, the holographic cooking demonstration module operative to:
receive holographic cooking demonstration information;
generate holographic cooking display information based on the holographic cooking demonstration information; and
send the holographic cooking display information to a holographic display device arranged to render one or more holographic cooking demonstration user interface elements in a three-dimensional space based on the holographic cooking display information.
